(19) United States
(12) Patent Application Publication
(10) Pub. No.: US 2013/0222598 A1
(43) Pub. Date: Aug. 29, 2013

(54) System and Method of On Demand Video Exchange Between On Site Operators and Mobile Operators

(71) Applicants: Abhay Singh Tomar, Bangalore (IN); Yuvraj Singh, Bangalore (IN); Bobby Narayanan, Bangalore (IN); Bhupesh Kumar Koli, Bangalore (IN)

(72) Inventors: Abhay Singh Tomar, Bangalore (IN); Yuvraj Singh, Bangalore (IN); Bobby Narayanan, Bangalore (IN); Bhupesh Kumar Koli, Bangalore (IN)

(73) Assignee: Honeywell International Inc., Morristown, NJ (US)

(21) Appl. No.: 13/403,359

(22) Filed: Feb. 23, 2012

(51) Int. Cl. H04N 7/18

(52) U.S. Cl. 348/158; 348/E07.085

(57) ABSTRACT

A method and apparatus are provided for viewing video images. The method includes the steps of an input of a video server receiving indicia identifying an image source providing a sequence of video images of interest and requesting that notification be sent to a user of a wireless electronic device, pushing a notification of the identified source through a persistent connection to the user of a wireless electronic device in response to the request, a user input of the wireless electronic device receiving input accepting the notification and the wireless electronic device automatically launching a viewing application installed on the wireless electronic device in response to the acceptance, the viewing application downloading video images from the image source to the wireless electronic device for viewing.

### FIELD

The field relates to video monitoring systems and more particularly to the monitoring of secure areas.

### BACKGROUND

Video monitoring systems for secure areas are generally known. Such systems can include any number of video cameras directed to different portions of the secure area and where video from each of the cameras is saved in one or more video recorders. Such systems may include an operator station where security personnel may monitor images from each of the cameras in real time.

The video monitoring system may also include one or more intrusion detection devices that detect intruders within the secure area. In the case of a monitoring system with many cameras, the activation of the intrusion detector may be used to alert a security guard to take steps to train the camera on the area of the activated intrusion detector.

In some cases, video from one or more of the camera may be processed to detect motion by intruders within a field of view of the camera. The use of motion detection may be used to reduce the need for security personnel.

In still other cases, secure areas may be accessible to the public. In these instances, security guards must be especially alert for suspicious activity. When suspicious activity is detected, it is often useful for security personnel to request the opinion of other security personnel in order to evaluate the risk. While the sharing of video sequences is relatively simple where advisory personnel are located at the same place as the security guard, it is not as simple where the advisory personnel are not at the same location. While available systems work well, they are not particularly well adapted for sharing images among security personnel. Accordingly, a need exists for better methods of sharing video among security personnel.

### BRIEF DESCRIPTION OF THE DRAWINGS

FIG. 1 is a block diagram of an image sharing system in the context of use within a security system shown generally in accordance with an illustrated embodiment; and

FIG. 2 is a system diagram showing signal flow between the security system and wireless electronic devices.

### DETAILED DESCRIPTION OF AN ILLUSTRATED EMBODIMENT

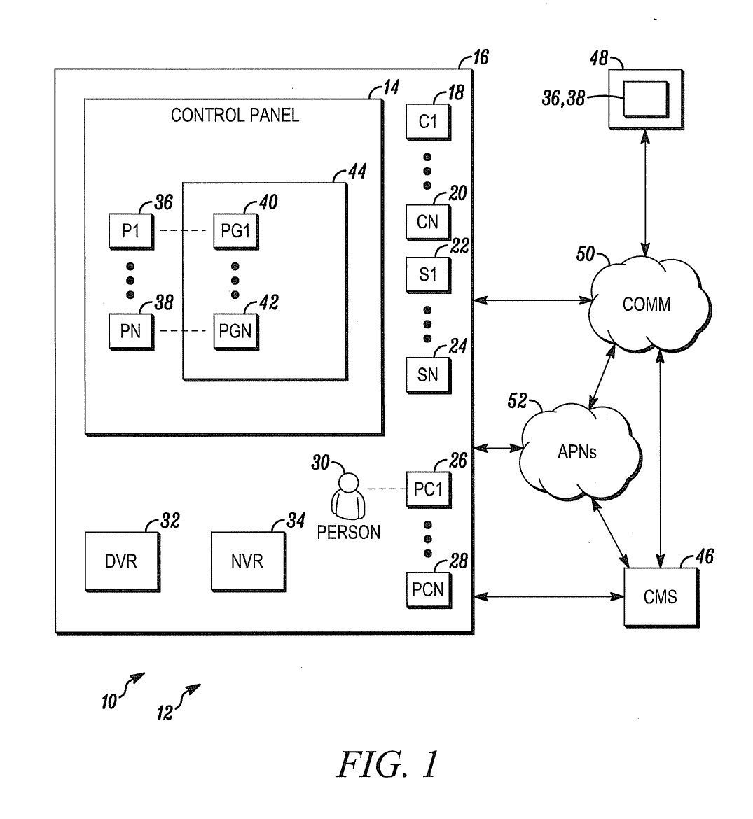

FIG. 1 depicts an image sharing system 10 shown in accordance with one illustrated embodiment. Under the illustrated embodiment, the image sharing system 10 may be used in any of a number of situations to share images collected by a video management system (VMS) with mobile electronic devices.

In this regard, video management systems may be widely deployed for purposes of security and surveillance. A typical VMS installation may include a number of video cameras used to monitor secure areas, one or more digital video recorders (DVRs) and/or network video recorders (NVRs) that save video from those cameras and one or more client viewer applications used for viewing video from the cameras or recorders. A person (e.g., a security guard) working within a control room of the security system may use the client viewer applications executing on a personal computer (PC) to access video of live scenes and/or events and alarms detected through the security system.

The use of client viewer applications operating on a PC in a control room have (in the past) suffered from a number of limitations. For example, an operator always has been physically present in the control room to monitor video provided through the viewer application. If the operator should want to share a video feed or camera sequence with another operator (or a site manager) upon the occurrence of an event, they too would have to be physically present in the control room.

The system 10 offers a number of features that avoid these limitations. These features provide video access to operators while they are on the move or are mobile. In this regard, the system 10 operates to share video feeds, events, images and messages between operators in a control room and mobile users (not physically present in the control room). The system 10 may also allow mobile operators to share video feeds.

In this regard, the system provides a method and apparatus for conveniently viewing video images in a number of different situations. The method may include the steps of an input of a video server receiving indicia identifying an image source providing a sequence of video images of interest and requesting that notification be sent to a user of a wireless electronic device and pushing a notification of the identified source through a persistent connection to the user of the wireless electronic device in response to the request. A user input of the wireless electronic device receives input from a user accepting the notification. The wireless electronic device responds by automatically launching a viewing application installed on the wireless electronic device in response to the acceptance. Once launched, the viewing application operates by downloading video images from the image source to the wireless electronic device for viewing by the user.

The image sharing system 10 may be used in any of a number of different situations including within a security system 12. The security system 12 may include a number of video cameras 18, 20 distributed throughout a secure area 16. The cameras 18, 20 may be coupled to a control panel 14 that receives the video from the cameras 18, 20, saves the video in one or more DVRs 32 and/or NVRs 34. The control panel may also display the video of each of the cameras 18, on one or more monitors or PCs 26, 28 for the benefit of a security person 30.

Included within the security system 12, within the PCs 26, 28 and within the portable electronic devices 48 (discussed in more detail below) may be one or more processors 36, 38 (embodied as apparatus) executing one or more computer programs 40, 42 loaded from non-transitory computer readable memory 44. In this regard, a processor (e.g., a file processor) 36, 38 of the control panel 14 may receive video from each of the cameras 18, 20 and save the frames of video from each of the cameras 18, 20 within a respective file and within one or more of the recorders 32, 34. The frames of video from each of the cameras 18, 20 may be saved by the recorder 32, 34 continuously or only when an event is detected.

In this regard, one or more event detectors 36, 38 may detect security events via the cameras 18, 20 or via one or more security sensors 22, 24. In this regard, the security sensors 22, 24 may include door switches, PIR detectors or any other type of detectors capable of detecting intruders. Similarly, one or more motion detections 36, 38 may detect motion within a field of view of each of the cameras 18, 20 by processing a sequence of frames from each of the cameras 18, 20 to detect changes among successive frames. In the event of the detection of an intrusion via activation of one of the sensors 22, 24 or the detection of motion by a motion detector, the event detector may send an alert to a security person 30 working at a monitor 26, 28.

Along with the alert, a time of the detected event and an identifier of a sensor 22, 24 and/or camera 18, 20 associated with the detected event may also be sent. Alternatively, an image processor associated with the event detector may automatically select a number of cameras 18, 20 associated with the detected event (i.e., a salvo of cameras) for the benefit of the security guard 30.

In response, a viewing processor 36, 38 of the monitor 26, 28 may receive the alert along with the identifier of the camera 18, 20 and process the notification accordingly. In this regard, the viewing processor may send a request retrieving real time video from a video server 36, 38 associated with the identified camera(s) and/or the recorders 32, 34 and display the retrieved video on the monitor 26, 28 for the benefit of the guard.

A set of control elements (e.g., softkey pushbuttons) displayed on the monitor 26, 28 by the viewing processor may also allow the guard to control the display of video by selecting a time interval of video to be viewed from the identified camera (or salvo of cameras). The control features may include a first push button to identify a starting time of viewed video, a second pushbutton for identifying an end of video and/or an interactive window for entering a time period of viewed video or identifiers of cameras that are to supply video. The controls may allow the guard to view video in real time or the guard may select a control element of the set that causes the viewing processor and server to retrieve video collected in the past at the time of the detected event from the recorders 32, 34.

The security guard 30 may view the video and conclude that the event does not represent a security threat and return to his/her regular duties. Alternatively, the security guard may conclude that the event is a threat and send an alarm message to a central monitoring station 46. The central monitoring station 46 may respond to the message appropriately (e.g., dispatching a security guard, dispatching the police, etc.).

As a still further alternative, the security guard 30 may be unsure of the nature or extent of the threat after viewing the video of the event and later video. In this case, the guard may decide to request review of the video by other security personnel (e.g., a supervisor) through a portable, wireless electronic device 48.

In this case, the guard 30 may activate another control feature displayed by the viewing processor on the monitor 26, 28 (e.g., a review request or “watch it” pushbutton) in order to initiate a process that sends the video of the event to the supervisor through the remotely located device 48. In this case, the activation of the “watch it” pushbutton causes the viewing processor to activate a push notification processor 36, 38 that pushes notification of the event to the electronic device 48. The notification to the electronic device 48 may include a token and a payload that together operate to provide an alert that notifies the user of the electronic device 48 of the reason for the notification and indicia identifying an image source providing a sequence of video images of interest. The indicia may include an identifier of a mobile viewing application 40, 42 within the electronic device 48, an identifier of the camera 18, 20 providing the video to be viewed and the starting and ending times of the video to be viewed.

Upon acceptance of the notification by the user, the mobile viewing application is automatically launched on a corresponding processor 36, 38 of the portable electronic device 48. Once launched, the mobile viewing processor may form a secure connection with the control panel 14 through a public communication system 50. Once set up, the secure connection may be used by the user of the electronic device 48 to view the frames of the event captured by cameras 18, 20 through the electronic device 48.

In general, the portable electronic device 48 may be any device capable of receiving push notifications (e.g., an Apple iPhone) through a persistent connection. Under one illustrated embodiment, the push notifications are provided by an appropriate push notification service (APNs) 52 maintained for the benefit of users of the electronic device 48 (e.g., an Apple push notification service).

In general, the mobile viewer processor of the electronic device 48 may register with the APNs 52 to receive push notifications. As noted above, the push notification sent from the APNs 52 to the device 48 includes a token and a payload. The token identifies the electronic device 48. The token is generated by the APNs 52 during initial registration and returned to the electronic device 48.

Upon receipt by the device 48 of the token during registration, the token is forwarded to the push notification processor 36, 38 associated with the monitor 26, 28. The token is received and saved by the push notification processor in order to later request that a push notification be sent by the APNs 52 to the portable device 48.

In general, the flow of notification data from the viewing processor of the monitor 26, 28 to the device 48 is one-way. The push notification processor composes a notification package to the APNs 52 that includes the device token for the client application (i.e., the mobile viewing processor) and the payload. The push notification processor sends the notification package to the APNs 52 which, in turn, pushes the notification to the device 48.

In order to send a push notification, the push notification processor within a PC 26, 28 first authenticates itself to the APNs 52 (in anticipation of sending a push notification). The push notification processor provides the APNs 52 with an identifier of the mobile viewing processor. In the case of an iPhone, the identifier is the bundle identifier of the mobile viewing application residing on the device 48.

The communication link between the push notification processor and APNs 52 and between the APNs 52 and device 48 may both be persistent connections. The link between the push notification processor and APNs 52 may use a binary interface. The binary interface may be asynchronous and use a streaming TCP socket design for sending push notifications to the APNs 52.

As noted above, the token is initially provided to the push notification processor of the PCs 26, 28 (through the device 48 from the APNs 52) as part of the set up process. The payload that is later sent along with the token by the push notification processor to the APNs 52 may be composed by the push notification processor as a JSON dictionary object that adheres to RFC 4627.

As an example, an operator (e.g., a guard) may be working at a control station 26, 28 in a Windows environment using a viewer application 40, 42 executing on a corresponding processor 36, 38. A list of users of electronic devices 48 may be provided on a display of the PC 26, 28. This list of users may be provided by a web services application that detects the web presence of the users and availability of devices 48 for receiving push notifications.

The operator may be viewing an event through a window displaying a salvo of images each image from a different camera 18, 20. The images selected by the operator 30 may be static or may be respective sequences that are displayed as they were recorded. The window may display real time images or images retrieved from memory. The window may be displayed with control elements used by the operator 30 that identify one or more of the cameras and the time interval. The operator may select the windows displaying the images enter identifiers of the camera(s) and time values to control the source and time interval of displayed images.

The operator may select one of the windows displaying an image sequence from a camera or window showing a salvo of images (or saved salvo) and “drag and drop” the salvo to an identifier of a user of a device 48 shown on the list. The step of dropping the salvo on a user in the list triggers a “watch it” web service function that sends the salvo to the designated user along with a “watch it” tag and user details via a push notification.

A set of web services (the push notification processor and APNs 52) operate to find the designated user designated on the list and pass the request (push notification) with the salvo information to the user of the device 48. The push notification is delivered to the designated user with a text/audible alert. The user may accept the notification and view the salvo along with the salvo information and an appropriate set of control elements that are used by the user of the device 48 to control the display in a manner similar to the function provided on the control station 26, 28.

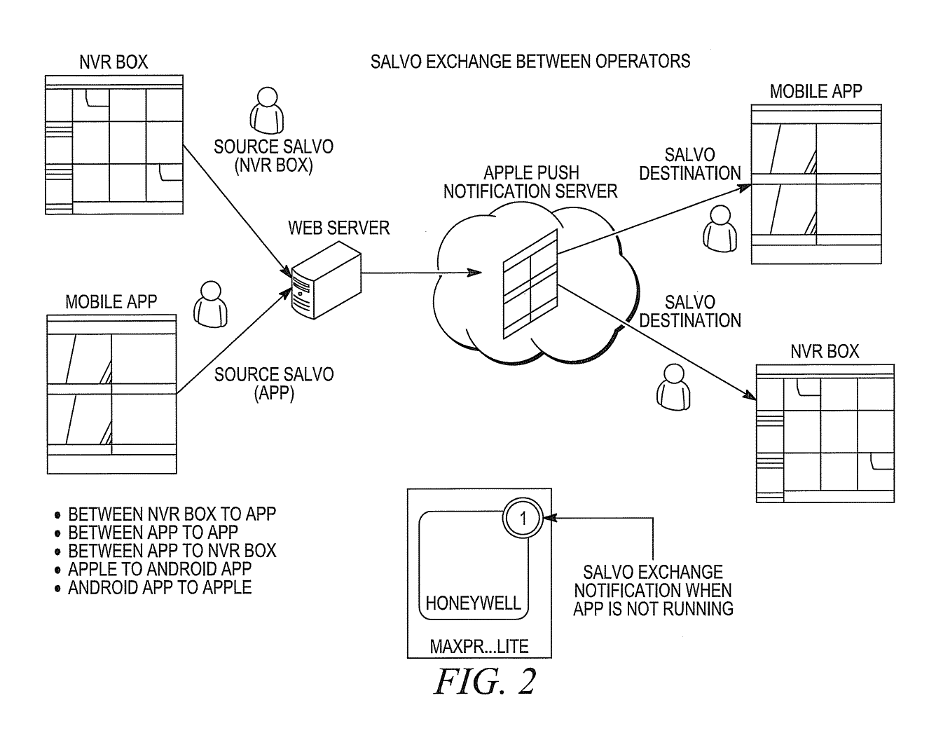

In another example (FIG. 2), a user working on a device 48 (e.g., on an iPad app in an Apple iOS environment, on an Android type device, etc.) is provided with a list of users of other devices 48 who are authorized (and registered) to view video from the system 10. This list is provided to the devices 48 by a web services application that detects the web presence (and availability to receive push notification) of other authorized operators of the devices 48.

An operator of a device 48 may receive and view video from the system 10 either based upon a push notification or because the mobile viewer application within the device 48 has independently formed a secure connection with the system 10 through the communication system 50 (as shown in the center panel along the left margin in FIG. 2). In this case, the operator of the device 48 can select the current salvo (or saved salvo) and “drag and drop” the selected salvo onto the identifier of another user (i.e., one of the users in the list and as shown along the right side of FIG. 2). This will independently trigger a “watch it” push notification through the APNs 52 to the other user of the other device 48 in a manner similar to the person 30 of the control station 26, 28 e.g., as shown in the bottom box of FIG. 2). The other user receives the push notification, accepts the notification and views the salvo in a manner similar to the first operator.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
an input of a video server receiving indicia identifying an image source providing a sequence of video images of interest and requesting that notification be sent to a user of a wireless electronic device;
pushing a notification of the identified source through a persistent connection to the user of the wireless electronic device in response to the request;
a user input of the wireless electronic device receiving input accepting the notification; and
the wireless electronic device automatically launching a viewing application installed on the wireless electronic device in response to the acceptance, the viewing application downloading video images from the image source to the wireless electronic device for viewing.

2. The method as in claim 1 wherein the image source further comprises an image processor consolidating images from a plurality of cameras into a single consolidated sequence of images.

3. The method as in claim 1 further comprising displaying real time, live video.

4. The method as in claim 1 further comprising displaying a sequence of video frames retrieved from a video recorder.

5. The method as in claim 4 wherein the indicia further comprises a beginning and ending time of the sequence of images.

6. The method as in claim 1 further comprising the video server sending a request for the notification to a notification service.

7. The method as in claim 1 further comprising the video server detecting an intruder in a secure area via an intrusion sensor.

8. The method as in claim 7 wherein the intrusion sensor further comprises a processor executing an application that detects motion in an image sequence from a security camera.

9. An apparatus comprising:
an input of a video server that receives indicia identifying an image source providing a sequence of video images of interest and requesting that notification be sent to a user of a wireless electronic device;
a notification of the identified source that is pushed through a persistent connection to the user of the wireless electronic device in response to the request;
a user input of the wireless electronic device receiving input that receives an acceptance of the notification; and
a viewing application installed of the wireless electronic device that is automatically launched in response to the acceptance, the viewing application downloading video images from the image source to the wireless electronic device for viewing.

10. The apparatus as in claim 9 wherein the image source further comprises an image processor that consolidates images from a plurality of cameras into a single consolidated sequence of images.

11. The apparatus as in claim 9 wherein the downloaded images further comprise real time, live video.

12. The apparatus as in claim 9 wherein the downloaded images further comprise a sequence of video frames retrieved from a video recorder.

13. The apparatus as in claim 12 wherein the indicia further comprises a beginning and ending time of the sequence of images.

14. The apparatus as in claim 9 further comprising the video server that sends a request for the notification to a notification service.

15. The apparatus as in claim 9 further comprising the video server that detects an intruder in a secure area via an intrusion sensor.

16. The apparatus as in claim 15 wherein the intrusion sensor further comprises a processor executing an application that detects motion in an image sequence from a security camera.

17. A system comprising:
a security system that protects a secure area;
a video server of the security system that receives indicia identifying an image source providing a sequence of video images of interest and that requests that notification be sent to a user of a wireless electronic device;
a push notification service that pushes notification of the identified source through a persistent connection to the user of the wireless electronic device in response to the request; and
a viewing application installed of the wireless electronic device that is automatically launched in response to acceptance of the pushed notification, the viewing application downloads video images from the image source to the wireless electronic device for viewing.

18. The apparatus as in claim 17 wherein the image source further comprises an image processor that consolidates images from a plurality of cameras into a single consolidated sequence of images.

19. The apparatus as in claim 17 wherein the downloaded images further comprise real time, live video.

20. The apparatus as in claim 17 wherein the downloaded images further comprise a sequence of video frames retrieved from a video recorder.
